(19) United States
(12) Patent Application Publication
(10) Pub. No.: US 2016/0081125 A1
(43) Pub. Date: Mar. 17, 2016

(54) ELECTRONIC SYSTEM FOR FORMING A CONTROL CHANNEL BETWEEN AN ELECTRONIC DEVICE AND A VIDEOTELEPHONE DEVICE

(71) Applicant: STARLEAF LTD, London (GB)

(72) Inventors: Richard Piers HEATLEY, Cambridge (GB); Samuel Thomas JANSEN, Newmarket (GB); Nicholas Ian MOSS, Middlesex (GB)

(21) Appl. No.: 14/831,773

(22) Filed: Aug. 20, 2015

(30) Foreign Application Priority Data
Aug. 20, 2014 (GB) 1414838.1

(51) Int. Cl. H04W 76/02; H04W 72/04

(52) U.S. Cl. CPC H04W 76/02; H04W 72/0406; H04W 84/12

(57) ABSTRACT

In some embodiments, an electronic system for forming a control channel between an electronic device and a videotelephone device such that the electronic device controls the videotelephone device comprises a videotelephone device in communication connection with the Internet and an electronic device in communication connection with the Internet. The electronic device is configured to request, over the Internet, a control channel to be formed between the electronic device and the videotelephone device. The electronic system also includes one or more computers in communication connection with the Internet. The one or more computers are configured to form the control channel between the electronic device and the videotelephone device by communication over the Internet in response to receiving the request by the electronic device over the Internet, such that the electronic device controls the videotelephone device.

### FIELD OF THE INVENTION

The present invention relates to an electronic system for forming a control channel between an electronic device and a videotelephone device.

### BACKGROUND OF THE INVENTION

As illustrated in FIG. 1, electronic devices such as mobile phones or smart phones 10 are used by individual company employees to make telephone calls to other individuals. These phones can usually connect to a corporate local area network 12, typically by WiFi (registered trade mark). Sometimes, during a call, it can be considered useful to, for example, continue the call over a corporate dedicated videotelephone device such as a video conferencing system 14 or video phone 16, for example, to include additional people on the call or to share documents. Because of the ease of use, but expense, of touch-screen displays of electronic devices such as smart phones, it has been considered useful to use the electronic device or smartphone to control the corporate dedicated videotelephone device like a remote control. However, corporate dedicated video conferencing systems are usually on a separate local area network (a video network) 18 to the corporate local area network 12 and there is no direct link between the corporate local area network 12 and the video network 18. As explained below, because of this, it has not been easily possible to pass a call over to the corporate dedicated video conferencing system 14 or video phone 16 from a call taking place on an employee's phone 10 nearby, for example, or to use the smartphone like a remote control.

In a corporate environment, a direct link or connection between a corporate local area network and a video network is neither usual nor considered desirable for security reasons. The video endsystems (corporate dedicated video conferencing system 14 and video phone 16) are put on a separate network to the corporate local area network to protect them from attack by viruses unwittingly brought in by employees, or attack by rogue employees trying to break into videoconferences to eavesdrop on conversations, for monetary gain or for theft of confidential material.

Allowing secure limited access through firewalls of user computing devices or electronic devices, such as smart phone 10, to a video endsystem 14,16 is considered to be very difficult because of the complexity of video protocols used on the video network 18 and the dynamic nature of a corporate local area network 12. Video protocols are complex and typically have to manage multiple streams of media packets from various addresses and ports as well as a variety of control protocols. Employees connecting their electronic devices to corporate networks typically involve a dynamic address assignment making it unpredictable where particular devices will be located on a corporate network. These two factors combined make firewall construction very difficult for allowing only authorized devices to control and stream to particular video endsystems or videotelephone devices at particular times. Furthermore, the separation of the electronic devices or user computing devices and the video conferencing system on different networks make it difficult for them to discover each other in order for them to communicate.

Existing consumer video endsystems such as the consumer device Apple TV (registered trade mark) allow connectivity with electronic devices or user computing devices such as smart phones, tablets or laptop computers. This interworking allows control messages and media streams to be transferred from the user's computing device to the video endsystem to allow the user to remotely control the video endsystem and to stream video or audio from the user's device to be played out using the endsystem's screen or speakers. FIG. 2 shows such a system. The system includes a home network 20 to which a laptop computer 22, a smartphone 24 and an Apple TV device 26 are in communication connection. The Apple TV device or set-top box is connected to a television 28. The laptop computer 22 and the smartphone and 24 can control and display content on the screen of the television attached to the Apple TV device via the home network.

The system requires that there is a direct network connection between the user's computing devices (the laptop computer 22 and the smartphone 24, in this example) and the video endsystem (the Apple TV device 26, in this example), usually by putting them on the same network. This restriction is acceptable and practical in a consumer environment where typically there is only a single network in a home. However, in a corporate environment, such a system is neither acceptable (in view of security risks) nor practical (in view of video networks and local area networks being separate in view of the security risks in linking them).

### SUMMARY OF THE INVENTION

Embodiments of the invention are a method and system which enable electronic devices or user computing devices to make use of video endsystems or videotelephone devices that are separated by the architecture of a corporate network.

The inventors of the present application have appreciated that a guaranteed common point of access between a video network and user computing devices is the Internet and, therefore, by deploying a cloud-based server or computer system a control channel between the communication end point device or electronic device and the video end systems or videotelephone device may be established.

The present invention is a set of methods for establishing this control channel and devices that implement such methods. In this way, a user's computing device or electronic device such as a smart phone, laptop or tablet connected to a corporate user wireless network or a mobile network can control video conferencing equipment or other videotelephone device on a corporate video network. In other words, a conference room or video conference system to remote device connection may be made over the cloud.

Embodiments of the present invention provide for an electronic device (such as a mobile device or mobile phone) to act as a remote control of a video telephone device (not the other end of a call) before a call has been established and that the video telephone device is a separate device to the electronic (mobile) device on a different network (intranet or local area network) to the electronic (mobile) device. Both the video telephone (first) device and the electronic (second) mobile device (for example, a smart phone on a 4G connection) are either outside a firewall, directly attached to the public Internet or are behind different firewalls preventing the other devices from directly see one another. The video telephone device and the electronic (mobile) device are not on the same intranet or local area network. In embodiments of the present invention, a videoconferencing call through which to tunnel the control messages is not established as the mobile device is not calling the other (video telephone) device. The purpose of the control channel of embodiments of the present invention is to cause a call to be set up between the other (video telephone) device and a third party. The two local devices (the electronic or mobile device and the video telephone device) do not use a control channel established by a call for sending control messages in order to communicate.

In embodiments of the present invention, the electronic or mobile (second) device or local device is capable of call control and media provision. It may receive instructions from the video telephone (first) device. The two devices are not closely connected. They are on completely different networks without direct communication.

The present invention relates to a device, method and system for allowing interworking between an ordinary computing device, user computing equipment or electronic device and a video endsystem or video telephone device on a video network.

The invention in its various aspects is defined in the independent claims below to which reference should now be made. Advantageous features are set forth in the dependent claims.

Arrangements are described in more detail below and take the form of an electronic system for forming a control channel between an electronic device and a videotelephone device such that the electronic device controls the videotelephone device. The electronic system comprises a videotelephone device in communication connection with the Internet; and an electronic device in communication connection with the Internet. The electronic device is configured to request, over the Internet, a control channel to be formed between the electronic device and the videotelephone device. The electronic system also includes one or more computers in communication connection with the Internet. The one or more computers are configured to form the control channel between the electronic device and the videotelephone device by communication over the Internet in response to receiving the request by the electronic device over the Internet, such that the electronic device controls the videotelephone.

In an aspect of the present invention, there is provided an electronic system for forming a control channel between an electronic device and a videotelephone device such that the electronic device controls the videotelephone device, the electronic system comprising: a videotelephone device in communication connection with the Internet; and an electronic device in communication connection with the Internet, wherein the electronic device is configured to request, over the Internet, a control channel to be formed between the electronic device and the videotelephone device; and one or more computers in communication connection with the Internet, wherein the one or more computers are configured to: form the control channel between the electronic device and the videotelephone device by communication over the Internet in response to receiving the request by the electronic device over the Internet, such that the electronic device controls the videotelephone device.

In another aspect of the present invention, there is provided a computer system for forming a control channel between an electronic device and a videotelephone device such that the electronic device controls the videotelephone device, the computer system comprising:

one or more computers in communication connection with the Internet, wherein the one or more computers are configured to form a control channel between an electronic device and a videotelephone device by communication over the Internet in response to receiving a request by the electronic device over the Internet to form a control channel between the electronic device and the videotelephone device such that the electronic device controls the videotelephone device.

In another aspect of the present invention, there is provided an electronic device for communication connection with the Internet, wherein the electronic device is configured to: request, over the Internet, a control channel to be formed between the electronic device in communication connection with the Internet and a videotelephone device also in communication connection with the Internet; and once the control channel is formed, send control signals over the control channel to the videotelephone device to control the videotelephone device.

In a yet further aspect of the present invention, there is a videotelephone device for communication connection with the Internet, wherein the videotelephone device is configured to: receive, over the Internet, a request for a control channel to be formed between an electronic device in communication connection with the Internet and the videotelephone device also in communication connection with the Internet; and once the control channel is formed, receive control signals over the communication channel from the electronic device to control the videotelephone device.

In another aspect of the present invention, there is provided a computerized method of forming a control channel between an electronic device and a videotelephone device for the electronic device to control the videotelephone device, the computerized method comprising: receiving at a computer system, over the Internet, a request from an electronic device to form a control channel between the electronic device and a videotelephone device; and in response to receiving the request, the computer system forming a control channel between the electronic device and the videotelephone device by communication over the Internet such that the electronic device controls the videotelephone device.

In a still further aspect of the present invention, there is provided a method for an electronic device to form a control channel between the electronic device and a videotelephone device over the Internet, the method comprising: the electronic device requesting, over the Internet, a control channel to be formed between the electronic device in communication connection with the Internet and a videotelephone device also in communication connection with the Internet; and once the control channel is formed, sending control signals over the control channel to the videotelephone device such that the electronic device controls the videotelephone device.

In a still further aspect of the present invention, there is provided a method for a videotelephone device to form a control channel between the videotelephone device and an electronic device over the Internet, the method comprising: the videotelephone device receiving, over the Internet, a request for a control channel to be formed between an electronic device in communication connection with the Internet and the videotelephone device also in communication connection with the Internet; and once the control channel is formed, the video telephone device receiving control signals over the control channel from the electronic device such that the electronic device controls the videotelephone device.

A computer program may be configured to carry out the methods above. A computer-readable medium may contain a set of instructions that causes a computer to perform the methods above. The computer-readable medium may be, for example, a hard disk drive, a solid state memory device, a CD-ROM or a DVD-ROM.

In any of the aspects above, the electronic device may be in communication connection with a first local area network that forms at least part of the electronic device's communication connection to the Internet. The videotelephone device may be in communication connection with a second local area network that forms at least part of the videotelephone device's communication connection to the Internet. The first local area network may not be in direct communication connection with the second local area network. The control channel may be formed over the Internet. The control channel may be formed through a third network in communication connection with the first local area network, the second local area network and the Internet. The control channel between the electronic device and the videotelephone device may pass through intermediate networks such as a demilitarized zone. The videotelephone device may comprise a videophone, a videoconferencing system, or a telepresence system. The electronic device may comprise a portable electronic device. The portable electronic device may comprise a smart phone, a tablet computer, or a laptop computer. In addition to forming the control channel, a relationship of trust between the electronic device and the videotelephone device may be formed, wherein the relationship of trust permits the electronic device to control the videotelephone device. The relationship of trust may be formed over the Internet in response to receiving the request by the electronic device over the Internet.

In addition to forming a control channel, a media channel may also be formed with the control channel for one or more media streams to be sent from the electronic device to the videotelephone device and vice versa.

### BRIEF DESCRIPTION OF THE DRAWINGS

The invention will be described in more detail, by way of example, with reference to the accompanying drawings, in which:

FIG. 1 (prior art) is a schematic diagram of a known telecommunication end point device and a known video conferencing system in a corporate environment;

FIG. 2 (prior art) is a schematic diagram of a known telecommunication end point device, computer and television in a consumer environment; and

FIGS. 3 to 5 are schematic diagrams illustrating a telecommunication system embodying an aspect of the present invention.

### DETAILED DESCRIPTION

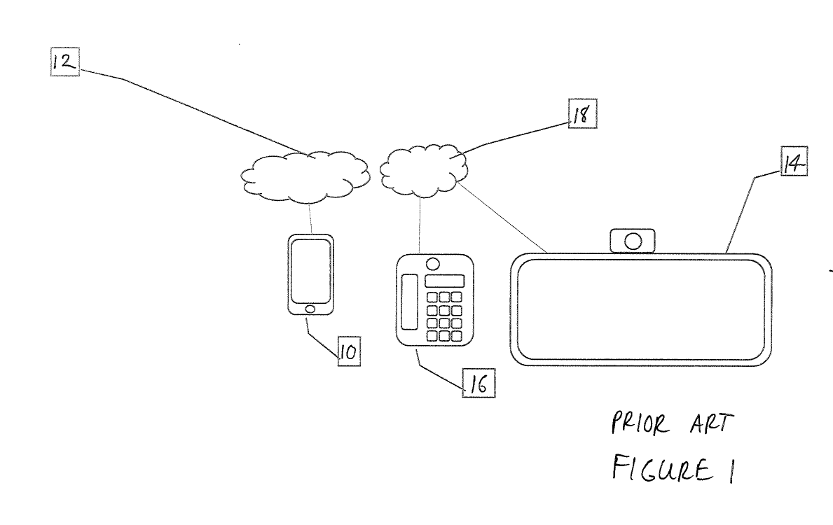

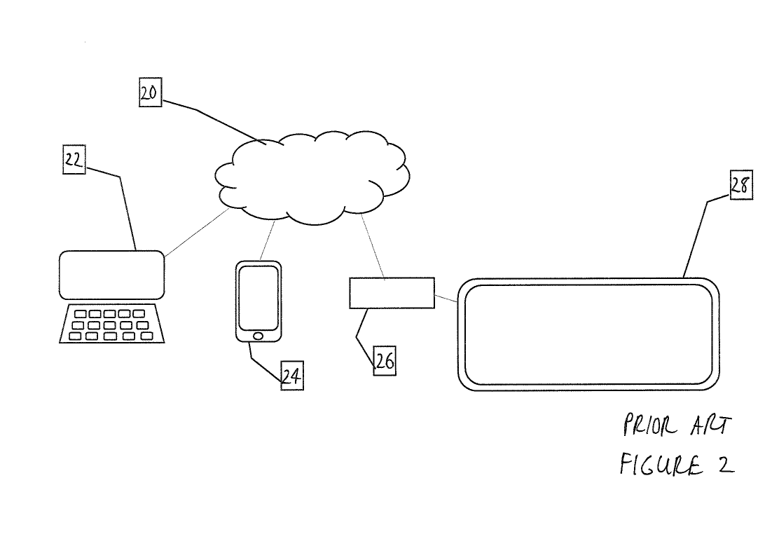

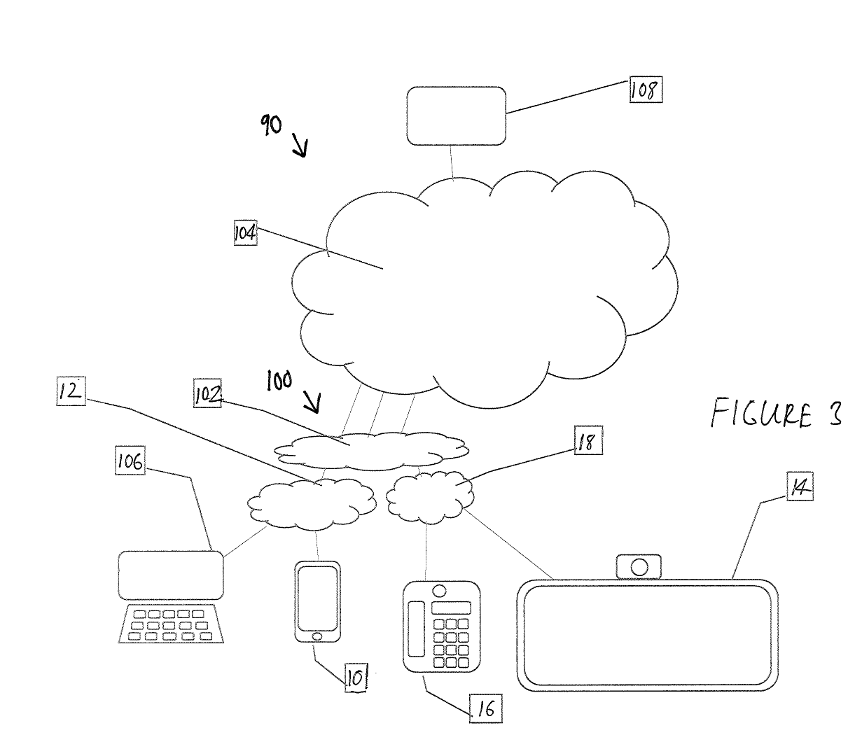

An electronic system 90 embodying an aspect of the present invention will now be described with reference to FIGS. 3 to 5. Some of the features of FIGS. 3 to 5 are the same as some of the features of the prior art of FIG. 1 and like features have been given like reference numerals.

FIG. 3 illustrates an example of a corporate network 100 that forms part of the electronic system 90. The corporate network 100 includes a first local area network in the form of an employee or corporate local area network, which, in this example is a wireless local area network or WiFi network 12. The corporate network also includes a second local area network in the form of a separate video local area network (a video network) 18 for a corporate videotelephone system, such a video conferencing system 18. That is to say, the first local area network is not in direct communication connection with the second local area network. As an alternative to a video conferencing system, the videotelephone system may be for example, a videophone or a telepresence system or other videotelephone system with at least some dedicated hardware for video and audio communications.

The corporate network 100 further includes a demilitarized zone (DMZ) 102. In the usual way, the DMZ is a network that includes the corporation's external-facing services or interface to another untrusted network, in this example, the Internet 104. The DMZ is in communication connection with both the corporate local area network 12 and the video network 18 and the Internet. A user's or employee's computing devices or electronic devices (smart phone 10 and laptop computer 106) are attached or in communication connection with the corporate or employee WiFi network 12. Videotelephone devices (video conference system 14 and video phone 16) are attached to or in communication with the video network 18. To emphasise, as is normal in corporate environments, and as explained in the background of the invention section above, there is no direct link between the employee WiFi network 12 and the video network 18. However, both of these networks have access to the Internet via the DMZ. Significantly, the electronic system 90 also includes a cloud-based video relay device 108 that is in communication connection with the Internet 104. The relay device is formed by a computer system, or one or more computers in communication connection with the Internet. Because the corporate and video networks and the relay device may all have communication connection over the Internet, the corporate and video networks can, therefore, both “see” the cloud-based video relay device.

The computing devices (smart phone 10 and laptop computer 106) include appropriate software or a computer program stored on them on a computer readable medium to issue or transmit a request to form a control channel with a video telephony device 14,16 to the employee network 12 and then over the Internet 104 to the relay device 108.

The relay device 108 includes a computer system or one or more computers or servers. These include appropriate software or a computer program stored on them on a computer readable medium. The computer or computers are configured to form a control channel between an electronic device, telecommunication end point device or employee computing device 10,106 and the videotelephone device 14,16 by communication over the Internet 104 in response to receiving an appropriate request from the telecommunication end point device or computing device over the Internet.

The communications relay cloud service or relay device 108 is a computer or computers that, in this example, are at well-known locations on the Internet. This allows simple firewall rules to allow the video endsystems or video telephone devices 10,106 to establish communication with the cloud service or relay device 108. As a users' device or computing device 10,106 will typically have access to much of the Internet 104 to facilitate web browsing, a user's device will be able to set up a connection to the communications relay device 108 through the company's firewall, typically, with little if any change required to the firewall rules.

In addition to forming the control channel, a relationship of trust is formed between the electronic device, such as a smartphone, and the videotelephone device. The relationship of trust permits the electronic device to control the videotelephone device. This relationship is formed over the Internet in response to receiving the request to form a control channel by the electronic device over the Internet. Several ways of achieving this are described below. The communications relay or relay device 108 has security mechanisms in place, such as in this example, a public key infrastructure (PKI) certificate to identify itself and to facilitate encryption of the communication connections from the video endsystems or video telephone devices 14,16 to the communications relay. A PKI is an arrangement that binds public keys with respective user identities by means of a certificate authority.

The communications relay 108 can identify the computing devices 10,106 that are attempting to attach using, for example, a username and password entered on the computing device, or a device identifier such as a digital certificate issued by the computing device.

The communications relay 108 may have a list of device pairs (each computing device 10,106 and video telephony device 14,16 form a device pair) that are allowed to communicate with one another. This may be a static list stored in storage or memory of the communications relay 108 or a dynamic list created by a call-control system (not shown) of the telecommunication system 90 or it may be based on some shared secret between the devices of the device pairs. Examples of mechanisms whereby a video endsystem or video telephony device 14,16 could establish a shared secret with a computing device 10,106 are set-out further below. Significantly, these mechanisms only operate when a user of a computing device 10,106 is very close to a video telephony device, typically within sight of the video telephony device. In this way, there is less likelihood that an unauthorised computing device would be able to control or have a communication connection with the video telephony device.

Example mechanisms whereby a video endsystem or video telephone device 14,16 could establish a shared secret with an electronic device or computing device 10,106 are as follows. A string of characters may be displayed on a screen or display of the video telephony device or spoken or issued through a loudspeaker of the video telephony device which could be input by the user of the computing device on the computing device. A short-range radio transmission such as a low power Bluetooth (registered trade mark), iBeacon (iBeacon (registered trade mark) is a location service that is part of the Apple (registered trade mark) operating system iOS (registered trade mark) that uses a Bluetooth low energy signal from a beacon detected by the device using iOS to indicate location of the device) or Near-Field Communication may be made by the video telephony device that needs to be detected by the computing device and a particular response made from the computing device to the video telephony device. A computer-readable graphic such as a QR code or other barcode or matrix bar code may be displayed on the video telephony device and this would need to be correctly scanned or detected by the computing device and a particular response made from the computing device to the video telephony device. A computer-readable audio signal may be played through the video telephony device that needs to be detected by the computing device and a response made from the computing device to the video telephony device.

Any of the above methods could incorporate the current time to ensure that the secret is short-lived and hence that the computing device or electronic device 10,106 requesting party is currently still in physical proximity to the video telephony device 14,16.

A user's computing device 10,106 may request that a relay channel be established to the desired video endsystem or video telephony device 14,16 based on authentication rules, shared secret and/or established call information.

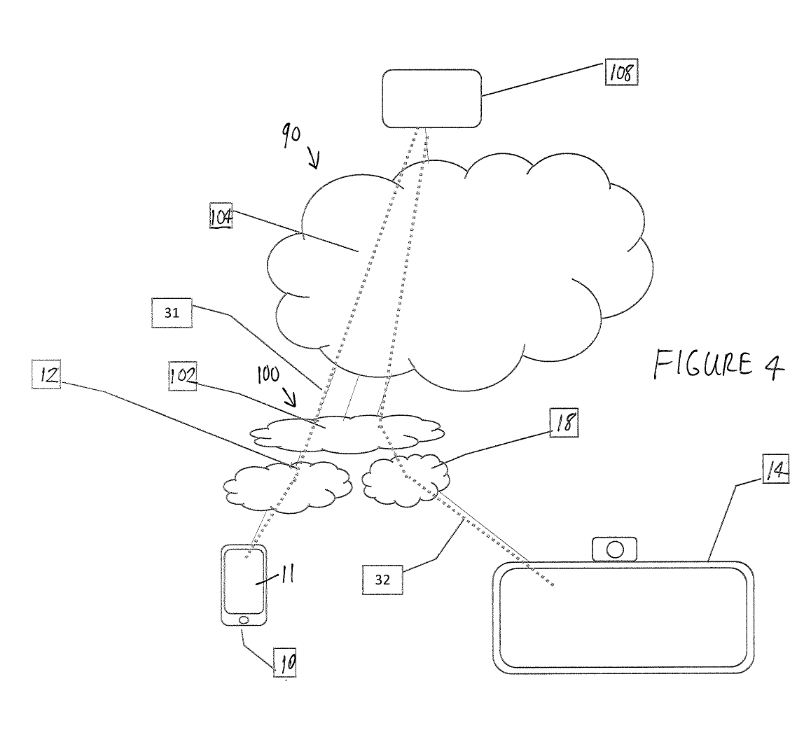

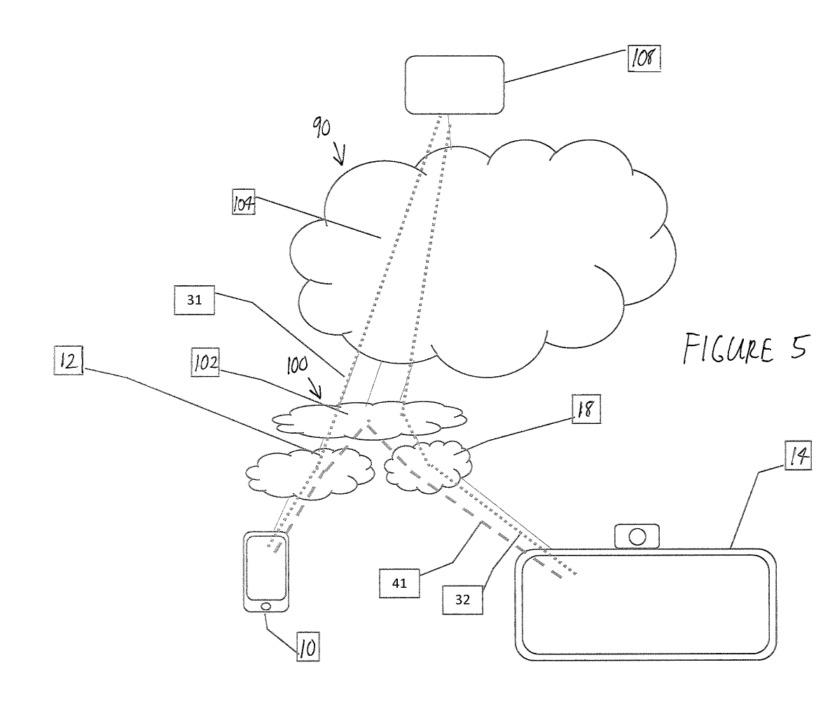

Once established, the computing device 10,106 to video endsystem or video telephony device 14,16 channel can optionally be encrypted, for instance by using another PKI certificate, to protect the channel from snooping by the owner of the relay device 108. This channel can be used to exchange details about the local network addresses of the user's computing device and the video endpoint 14,16. This exchange of information can be used to set up a direct communications path between the devices (the computing device 10,106 and the video telephony device 14,16) if possible in the network architecture and if permitted by any intermediate firewalls as explained in more detail below with reference to FIG. 5. First, though, FIG. 4 is discussed.

FIG. 4 illustrates an example of the telecommunication system of FIG. 3 in use. FIG. 4 is similar in most respects to FIG. 3 and like features have been given like reference numerals.

FIG. 4 illustrates a computer device or electronic device in the form of a smartphone 10 in which a user has initiated a request to set up a control channel between the smartphone 10 and video telephone device 14. In this example, the request is made by a user selecting an appropriate button on the touch screen 11 of the smart phone. The request includes a digital certificate issued by the smartphone to identify it. The request is sent over a WiFi communication connection between the smart phone and the corporate network 12. The request is transmitted from the corporate network to the DMZ 102 over the Internet 104 to the relay device 108 including the digital certificate. On receipt of the request, the relay device checks that the digital certificate represents a device that is authorised to control the video telephony device 14. If the digital certificate is authorised to control the video telephony device then a control channel 31,32 is established or formed between the smart phone and the video telephony device by the relay device. Significantly, the control channel is formed over the Internet. The smartphone connects to the cloud relay device using part of the communication channel or connection 31 and the video endsystem or video telephoned device connects to the cloud relay device using another part of the communication connection 32.

The control channel or connection 31 from the smartphone to the delay device includes a path extending from the smart phone via a WiFi communication connection to the corporate network 12, from the corporate network to the DMZ 102, over the Internet 104 and to the relay device 108. The control channel or connection 32 from the relay device to the video telephone device 14 extends from the relay device, over the Internet to the DMZ, to the video network 18 and then to the video telephone device 14.

The control channel 31,32 allows interworking between the ordinary computing device, user computing equipment or electronic device 11 and the video endsystem or video telephone device 14 on a video network 18. For example, the control channel 31,32 can be used to tunnel control protocols such as HTTP (hyper text transfer protocol) to allow a user's computer device 10,106 to access the user interface of the video endpoint or video telephony device 14,16 and in this way to act like a remote control. The channel 31,32 can be used to tunnel other call-control protocols such as SIP (session initiation protocol) to allow the user's computer device to call-control requests to the video endpoint to instruct it to make or receive calls. The channel 31,32 can be used to tunnel other real-time protocols such as RTP (real-time transport protocol) to allow the user's computer device to send real-time media such as a screen-share, camera feed or audio to the video endpoint. Thus, in addition to forming a control channel, a media channel may also be formed with the control channel for one or more media streams to be sent from the electronic device to the videotelephone device and vice versa.

FIG. 5 illustrates an example of the telecommunication system of FIG. 3 in use. FIG. 5 is similar in most respects to FIGS. 3 and 4 and like features have been given like reference numerals.

FIG. 5 shows an example of the smartphone 10 and video endsystem or videotelephone device 14 having set up a relay channel or control channel 31,32, then setting up a direct communication channel 41 through the company's network traversing across different networks.

As explained above, once established, the computing device 10,106 to video endsystem or video telephone device 14,16 channel can be encrypted, for instance by using another PKI certificate, to protect the channel from snooping by the owner of the relay device 108. This channel can be used to exchange details about the local network addresses of the user's computing device and the video endpoint or video telephone device. This exchange of information can be used to set up a direct control path or channel 41 between the devices (the computing device 10,106 and the video telephony device 14,16) if possible in the network architecture and if permitted by any intermediate firewalls. This arrangement is explained with reference to FIG. 5.

Once a communication connection has been established between computing device 10 and video telephone device via relay device 108, either or both of these devices may request that a direct connection is made between them. The connection could be established from either end or both ends simultaneously to facilitate firewall traversal.

In the example of FIG. 5, the smart phone 10 requests a direct connection with the video telephone device 14. Appropriate signalling is sent along the communication path 31 to the relay device 108 and the relay device sends appropriate signalling along the communication path 32 to the video telephone device. This signalling initiates an exchange of details about local network addresses of the computing device 10 and the video endpoint 14. Once each of the local network addresses is established by the other device, a direct communication connection 41 is established or formed between them over the DMZ 102. The direct communication connection between the smart phone and video telephony device is therefore established by a WiFi link from the smart phone to the corporate network 12, from the corporate network to the DMZ, from the DMZ to the video network 18 and finally from the video network to the video telephone device. Thus, in this arrangement a third network (the DMZ) is used to connect a first network (the corporate network) to a second network (the video network).

This arrangement allows the firewalls to be kept simple. This results in a safe and secure system for a relatively complex arrangement. The complex arrangement involves tunnel setup and authentication before any packets can be sent from smartphone to video telephone system as well as often, in practice, many smartphones, all with random addresses, and lots of video telephone systems. A simple firewall means that mistakes are less likely to be made when the firewall is set up. Furthermore, if complex firewall rules allowed all of the electronic devices or smartphones to communicate or control all of the video telephone systems then any one of them infected by a virus could potentially infect all of the video telephone systems. This problem is prevented by the simple firewall arrangement described above.

Alternatively, if the employee network and the video network firewalls are both directly connected to the Internet then the direct connection could be established through the Internet rather than through a DMZ.

The direct path may be used for plain unencapsulated protocols such as HTTP, SIP or RTP or it may be a similar type of channel to the channel established via the relay device 108. If a direct channel can be established of the same type as the channel through the cloud relay device 108 then it can be used to replace the channel through the cloud relay device.

As with the control channel via the relay device 108, the direct communication channel 41 allows interworking between the ordinary computing device, user computing equipment or electronic device 10 and the video endsystem or video telephone device 14 on a video network 18. For example, the direct communication channel 41 can be used to tunnel other control protocols such as HTTP to allow a user's computer device 10,106 to access the user interface of the video endpoint or video telephony device 14,16. The direct channel can be used to tunnel other call-control protocols such as SIP to allow the user's computer device to call-control requests to the video endpoint to instruct it to make or receive calls. The direct channel can be used to tunnel other real-time protocols such as RTP to allow the user's computer device to send real-time media such as a screen-share, camera feed or audio to the video endpoint.

Embodiments of the present invention have been described. It will be appreciated that variations and modifications may be made to the described embodiments within the scope of the present invention.

1. An electronic system for forming a control channel between an electronic device and a videotelephone device such that the electronic device controls the videotelephone device, the electronic system comprising:
a videotelephone device in communication connection with the Internet; and
an electronic device in communication connection with the Internet, wherein the electronic device is configured to request, over the Internet, a control channel to be formed between the electronic device and the videotelephone device; and
one or more computers in communication connection with the Internet, wherein the one or more computers are configured to:
form the control channel between the electronic device and the videotelephone device by communication over the Internet in response to receiving the request by the electronic device over the Internet, such that the electronic device controls the videotelephone device.

2. An electronic system according to claim 1, wherein the electronic device is in communication connection with a first local area network that forms at least part of the electronic device's communication connection to the Internet.

3. An electronic system according to claim 2, wherein the videotelephone device is in communication connection with a second local area network that forms at least part of the videotelephone device's communication connection to the Internet.

4. An electronic system according to claim 3, wherein the first local area network is not in direct communication connection with the second local area network.

5. An electronic system according to claim 1, wherein the control channel is formed over the Internet.

6. An electronic system according to claim 5, wherein the control channel is formed through a third network in communication connection with the first local area network, the second local area network and the Internet.

7. An electronic system according to claim 1, wherein the control channel between the electronic device and the videotelephone device passes through a demilitarized zone.

8. (canceled)

9. (canceled)

10. (canceled)

11. An electronic system according to claim 1, wherein the one or more computers are configured to:
form the control channel and in addition form a relationship of trust between the electronic device and the videotelephone device, wherein the relationship of trust permits the electronic device to control the videotelephone device.

12. An electronic system according to claim 11, wherein the one or more computers are configured to:
form the relationship of trust over the Internet in response to receiving the request by the electronic device over the Internet.

13. A computer system for forming a control channel between an electronic device and a videotelephone device such that the electronic device controls the videotelephone device, the computer system comprising:
one or more computers in communication connection with the Internet, wherein the one or more computers are configured to form a control channel between an electronic device and a videotelephone device by communication over the Internet in response to receiving a request by the electronic device over the Internet to form a control channel between the electronic device and the videotelephone device such that the electronic device controls the videotelephone device.

14. A computer system according to claim 13, wherein the electronic device is in communication connection with a first local area network that forms at least part of the electronic device's communication connection to the Internet.

15. A computer system according to claim 14, wherein the videotelephone device is in communication connection with a second local area network that forms at least part of the videotelephone device's communication connection to the Internet.

16. A computer system according to claim 15, wherein the first local area network is not in direct communication connection with the second local area network.

17. A computer system according to claim 13, wherein the control channel is formed over the Internet.

18. A computer system according to claim 14, wherein the control channel is formed through a third network in communication connection with the first local area network, the second local area network and the Internet.

19. A computer system according to claim 13, wherein the control channel between the electronic device and the videotelephone device passes through a demilitarized zone.

20. (canceled)

21. (canceled)

22. (canceled)

23. A computer system according to claim 13, wherein the one or more computers are configured to:
form the control channel and in addition form a relationship of trust between the electronic device and the videotelephone device, wherein the relationship of trust permits the electronic device to control the videotelephone device.

24. A computer system according to claim 24, wherein the one or more computers are configured to:
form the relationship of trust over the Internet in response to receiving the request by the electronic device over the Internet.

25. An electronic device for communication connection with the Internet, wherein the electronic device is configured to:
request, over the Internet, a control channel to be formed between the electronic device in communication connection with the Internet and a videotelephone device also in communication connection with the Internet; and
once the control channel is formed, send control signals over the control channel to the videotelephone device to control the videotelephone device.

26. An electronic device according to claim 25, wherein the electronic device is in communication connection with a first local area network that forms at least part of the electronic device's communication connection to the Internet.

27-51. (canceled)
